(19) United States
(12) Patent Application Publication
(10) Pub. No.: US 2010/0330826 A1
(43) Pub. Date: Dec. 30, 2010

(54) Speed Wire Device

(76) Inventor: Bruce G. Phillips, Gilbert, AZ (US)

Correspondence Address: AVERILL & GREEN, 8244 PAINTER AVE., WHITTIER, CA, 90602, US

(21) Appl. No.: 12/822,113

(22) Filed: Jun. 23, 2010

Related U.S. Application Data
(60) Provisional application No. 61/220,941, filed on Jun. 26, 2009.

(51) Int. Cl. H01R 13/648; H01R 13/60

(52) U.S. Cl. 439/101; 439/535

(57) ABSTRACT

A speed wire device connects to standard screw terminals on traditional receptacle and switch devices. The speed wire device includes forked lugs positioned to engage screw terminal present on known traditional electrical receptacle and switch devices. The forked lugs engage the standard screw terminals and prevent miss-wiring during finally assembly after dry wall installation. The speed wire device may be a single piece device, or a two piece plug together device allowing simple “hot-swapping” of traditional receptacle and switch devices in applications were power must remain on, for example, in hospitals.

The present application claims the priority of U.S. Provisional Patent Application Ser. No. 61/220,941 filed Jun. 26, 2009, which application is incorporated in its entirety herein by reference.

### BACKGROUND OF THE INVENTION

The present invention relates to wiring devices and in particular to connecting wires to electrical receptacles and switches.

Traditional-style wiring devices such as receptacles (including single, duplex, and Ground Fault Circuit Interrupter (GFCI) receptacles), and switches (including single-pole, 3-way and 4-way) are commonly used in residential, commercial and industrial settings. Such devices are directly electrically connected to permanent in-wall wiring using individual screw type connections for each wire.

The predominate amperage rating of such devices is 15 amperes and 20 amperes, although other special purpose devices may have other ratings. The design of most of these devices has not significantly changed in the last 25 years providing standardization in the distribution of power and the subsequent use of appliances and the like in buildings throughout the U.S., although different configurations, because of varying voltage requirements, exist in other countries. Unlike the majority of these devices, GFCI devices have undergone changes in design in recent years to address UL-requirements for personal safety issues, however the basic shape and style of the GFCI devices has remained unchanged.

Unfortunately, known wiring device cannot be “hot’ swapped—meaning that the circuit must be turned off when a broken wiring device requires replacement, which also removes power from other wiring devices on that same circuit. Many facilities, such as healthcare facilities, operate continuously and are not free to open circuits for repairs.

U.S. Pat. No. 6,994,585 for “Electrical Wiring System”, assigned to Pass & Seymour, discloses a receptacle having a female connector, electrically connected to in-wall wiring, which female connector may be safely hot plugged into and unplugged from a recessed male receptacle on the rear of a cooperating electrical device, without risk of shorting a circuit or personal injury to an installer. Many organizations, such as healthcare facilities, like this feature because the broken device can be changed without shutting off the entire circuit (i.e., “hot swapped”) and thus without affecting other wiring devices on the same circuit. Other similar hot swappable devices have been subsequently introduced.

The female plug of the '585 patent may be electrically connected to the building in-wall wiring and then, after wall finishes are applied (i.e. paint, wallpaper, etc.), the wiring device may simply be “plugged in” to the previously installed female plug. Time is potentially saved because individual wires do not require individual connection using the traditional-style wiring device screws. As a result, a less skilled workman may be employed to install wiring devices in the wall and quality is enhanced because there can be no issues with mis-wiring. Unfortunately, the known hot swappable devices require expensive dedicated electrical devices and therefore do not allow the use of existing or low cost electrical devices.

As a result, the known hot swappable devices require respective manufacturers to completely re-design the wiring device(s) to incorporate a recessed male receptacle connection. Each and every device type required re-design, special molds and other manufacturing considerations and then stocking of these new devices to accommodate customer requirements. Stocking requirements further grow because wiring device come in a myriad of colors. Further, hot swappable device manufacturers cannot eliminate their traditional-style wiring devices that have existed in the marketplace for decades and these devices remain standard catalogue items and are the predominate offering of the swappable device manufacturers due mostly to cost (known hot swappable devices cost approximately three times as much as a comparable traditional device).

Further, many contractors and building owners do not like the known hot swappable devices because once installed they are “locked-in” to replacing broken devices with like devices. A traditional receptacle manufactured by a variety of manufacturers may be replaced with a traditional device manufactured by any other company. Unfortunately, receptacle or switch portions of the known hot swappable devices must be replaced by a like device from the same manufacturer because interfaces are not interchangeable. Therefore, a hospital building having an electrical system including known hot swappable devices, is required to use the same manufacture's devices for the life of the building, unless the female plugs are removed from the building wiring and replaced, which would allow the installation of any traditional device by any manufacturer.

### BRIEF SUMMARY OF THE INVENTION

The present invention addresses the above and other needs by providing a speed wire device which connects to standard screw terminals on traditional receptacle and switch devices. The speed wire device includes forked lugs positioned to engage screw terminal present on known traditional electrical receptacle and switch devices. The forked lugs engage the standard screw terminals and prevent miss-wiring during finally assembly after dry wall installation. The speed wire device may be a single piece device, or a two piece plug together device allowing simple “hot-swapping” of traditional receptacle and switch devices in applications where power must remain on.

In accordance with one aspect of the invention, there is provided a speed wire device according to the present invention which is compatible with existing traditional receptacle and switch devices. Investments in new tooling, molds, UL-listing costs, marketing, warehousing and distribution costs are thus minimized. In many instances, the speed wire device according to the present invention also works with traditional receptacle and switch devices from different manufacturers which use standard terminal screw patterns. Use of the speed wire device according to the present invention with existing traditional receptacle and switch devices may reduce costs by as much as 67 percent compared to known hot swappable devices.

In accordance with another aspect of the invention, there is provided a two piece speed wire device according to the present invention which when used with side guards, commonly found on many receptacle and switch devices, or if the receptacle and switch device is taped at its sides, may be safely “hot swapped” by unplugging a pigtail device from the rear. An adapting device is attached to the electrical device, and the pigtail device, which plugs into the rear of the adapting device, is electrically connected to the in-wall wiring. Even if the receptacle or switch device terminal screws are exposed, the speed wire device facilitates hot-swapping if care is taken by the installer (e.g., wearing insulated gloves) because no tools are needed nor are the terminal screws loosened to change a wiring device on a live circuit.

In accordance with yet another aspect of the invention, there is provided a speed wire device according to the present invention which includes a female connector which may be pre-installed during the rough-in phase of a project and traditional receptacle and switch devices may then be quickly and safely installed after wall finishes by low-skilled labor.

In accordance with yet another aspect of the invention, there is provided a speed wire device according to the present invention which allows a contractor or building owner to replace a broken receptacle and switch device with a standard receptacle and switch device and eliminates the need to purchase expensive and special hot-swapping receptacle devices or switch devices required by known hot-swapping devices.

In accordance with yet another aspect of the invention, there is provided a speed wire device according to the present invention which may be used in prefab construction. The speed wire device eliminates the need to cut and strip individual wires and form the “hook” on one end needed to wrap around screw type terminals, and eliminates the labor to attach the individual conductors to the terminal screws. Waste is also eliminated because wires do not require individual fabrication steps. The cost of equipment to fabricate these wires is also avoided and cutting, splicing, and forming of wires required during the finish phase of construction is also eliminated.

In accordance with yet another aspect of the invention, there is provided a speed wire device according to the present invention which may be used with traditional (not prefab) wiring. The speed wire device is easily connected to building wiring before dry walling. After dry walling, all that is required is to place the speed wire device on the rear of the wiring device and tighten screws which may be performed by less-skilled labor.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a front perspective view of a prior art electrical receptacle device.

FIG. 2 is a rear perspective view of the prior art electrical receptacle device.

FIG. 3 is a rear perspective view of the prior art electrical receptacle device configured for “hot swapping”.

FIG. 4A is a rear perspective view of a single piece speed wire device according to the present invention positioned to connect to the prior art electrical receptacle device.

FIG. 4B is a rear perspective view of the single piece speed wire device according to the present invention connected to the prior art electrical receptacle device.

FIG. 5A is a front perspective view of a two piece speed wire device according to the present invention.

FIG. 5B is a rear perspective view of the two piece speed wire device according to the present invention.

FIG. 6 is a rear perspective view of the two piece speed wire device according to the present invention with covers removed to show internal elements.

FIG. 7 shows an adapting device according to the present invention with pins for electrically connecting to a known Ground Fault Circuit Interrupter (GFCI) receptacle.

FIG. 8 shows a pigtail device according to the present invention including wire receptacles and screw type terminals for connection to in-wall wiring.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

In the present application permanently connected refers to an electrical connection which is not disturbed during normal maintenance. The connection is permanent in the sense that it cannot be broken to replace a damaged element or major construction, or the like. Specifically, in the following description, a pigtail device is permanently connected to in-wall wiring in the sense that the connection between the pigtail device and the in-wall wiring is not broken to replace a standard electrical device, such as a receptacle or a switch.

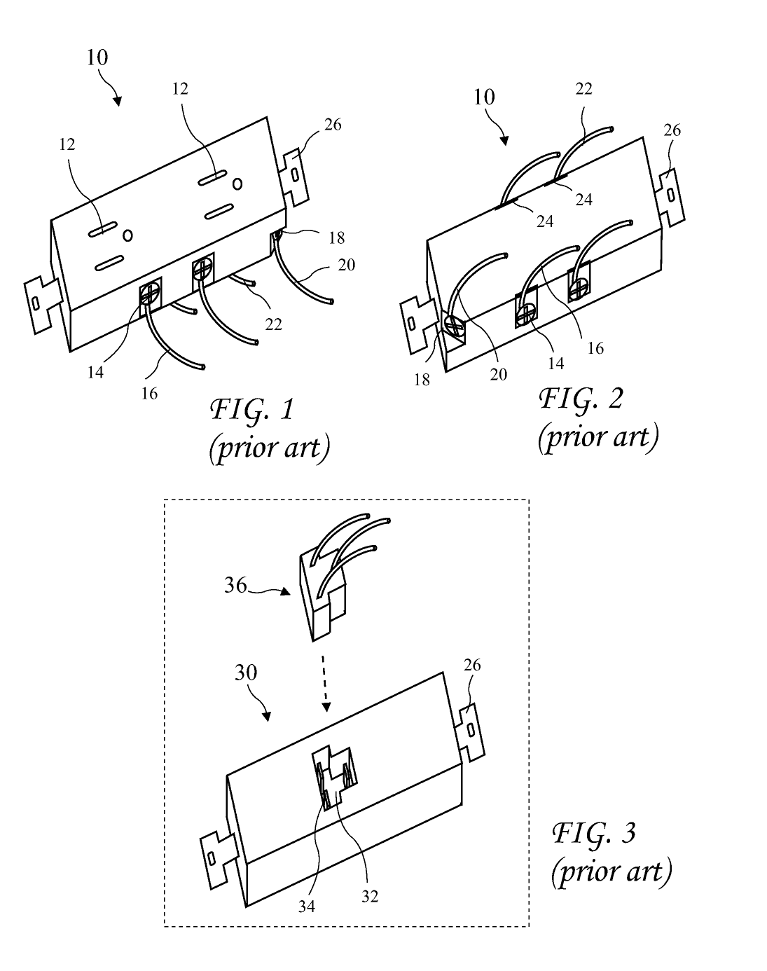

A front perspective view of a prior art standard electrical receptacle device 10 is shown in FIG. 1 and a rear perspective view of the prior art traditional electrical receptacle device 10 is shown on FIG. 2. The receptacle device 10 includes female electrical connections 12 for known electrical plugs and screw type terminals 14 and 24 for connecting neutral wires 16 and hot wires 22. A screw type terminal 18 is provided for connecting a ground wire and a ground strap (or metal yoke) 26 is provided for grounding and attaching the receptacle device 10 to an electrical box the receptacle device 10 is mounted in. In normal use, the wires 16, 20, and 22 are connected to the receptacle device 10 following wall finishing, (e.g., wallpaper, paint, tile, etc.) or when the receptacle device 10 is replaced due to failure. In either instance, the power provided to the wires 16 and 22 must be disconnected to prevent shorts between the wires 16 and 22 and shocks to the installer. In some uses, for example medical facilities, it is problematic to remove power from a circuit providing power to one device location because the same circuit provides power to essential equipment at other device locations, i.e., repairs to one device at one location affects all the devices on the same circuit.

One solution allowing “hot swapping” of the receptacle device 10 is the known hot swappable receptacle device 30 shown in FIG. 3. The receptacle device 30 has a mouth (or recessed area) 32 on a rear surface and male connectors 34 residing inside the mouth 32. A plug 36 is keyed to the mouth 32 and includes female connectors (not shown) for electrically connecting to the male connectors 34 to connect the receptacle device 30 to an in-wall electrical circuit and to allow safe initial connection and hot swapping without disconnecting power to the circuit. Unfortunately, the receptacle device 30 is both expensive and is not compatible with the receptacle device 10, or a device similar to the receptacle device 30 but manufactured by another manufacturer.

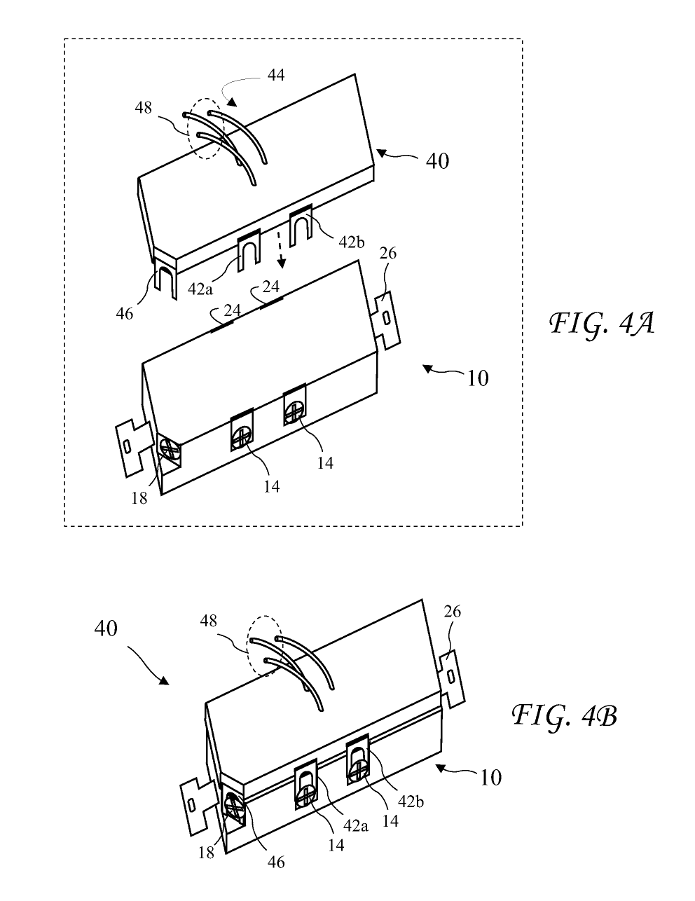

A rear perspective view of a single piece speed wire device 40 according to the present invention, positioned to connect to the prior art electrical receptacle device 10, is shown in FIG. 4A and a rear perspective view of the single piece speed wire device 40, connected to the prior art electrical receptacle device 10, is shown in FIG. 4B. The single piece speed wire device 40 includes connectors (e.g., forked lugs) 42a, 42b, 44 (not shown), and 46 positioned to align with and engage the screw type terminals 14, 18, and 24 of the traditional receptacle device 10. The single piece speed wire device 40 includes lead wires 48 which may remain connected to in-wall during installation or swapping the receptacle 10. The single piece speed wire device 40 allows only a single alignment thus preventing miss-wiring and prevents loose wires from shorting out when a circuit is not electrically disconnected during maintenance.

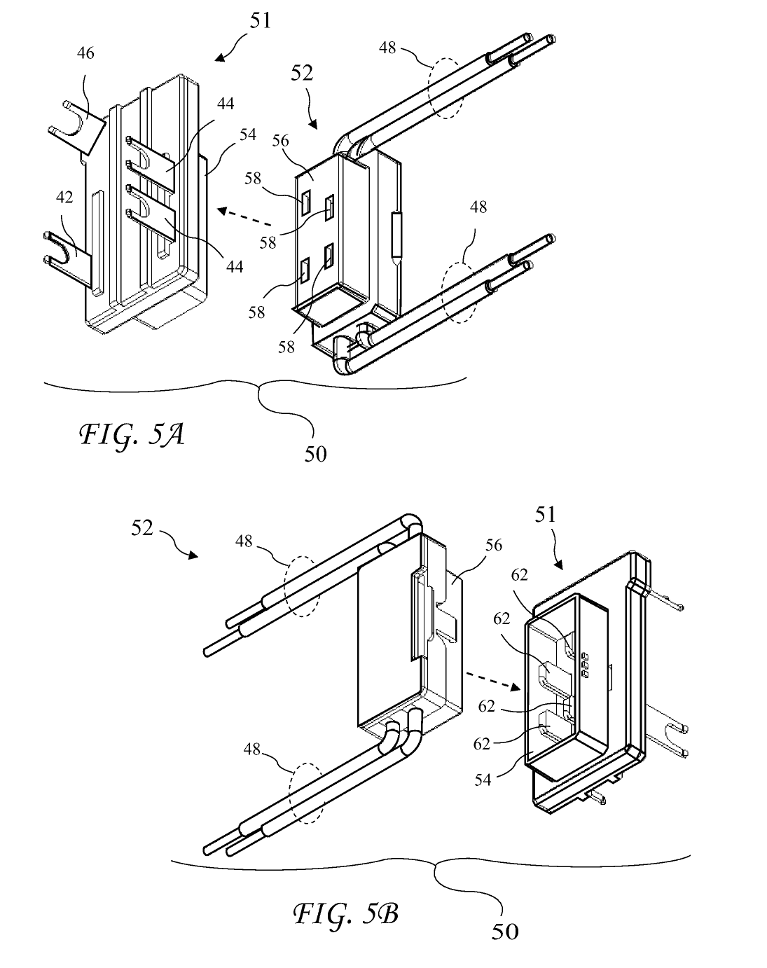

A front perspective view of a two piece speed wire device 50 according to the present invention is shown in FIG. 5A and a rear perspective view of the two piece speed wire device 50 is shown in FIG. 5B. The two piece speed wire device 50 provides the same utility as the single piece speed wire device 40, but additionally facilitates hot swapping. The two piece speed wire device 50 comprises a pigtail device 52 normally left electrically connected to an in-wall hot circuit, and an adapting device 51 for attaching to the traditional receptacle 10. The adapting device 51 includes a recessed receiving area 54 containing male connectors 62. The pigtail device 52 includes an insertable portion 56 containing female connectors 58 arranged for electrical connection with the male connectors 62.

The speed wire devices 40 and 50 preferably includes three wires 48 (one hot wire) or four wires 48 (two hot wires), but may include two wires 48, or five or more wires 48, as required for a particular installation. For example, including two hot wires allows a receptacle to be half switched, which is a common installation. For instance, a black hot wire feeds the top half of the receptacle and a red hot wire feeds the bottom half of the receptacle. Either speed wire device 40 or 50 facilitates this feature but generally, only the black hot wire is required because most installations do not require the half switching feature. By simply not including the red wire and associated fork connectors, the speed wire device becomes a single circuit connector. The same molded parts may be used for either version to reduce cost.

While the present invention is described above in cooperation with a receptacle device 10, the present invention may be configured to cooperate with a standard electrical device comprising a switching device of various types such as single-pole, 3-way and 4-way.

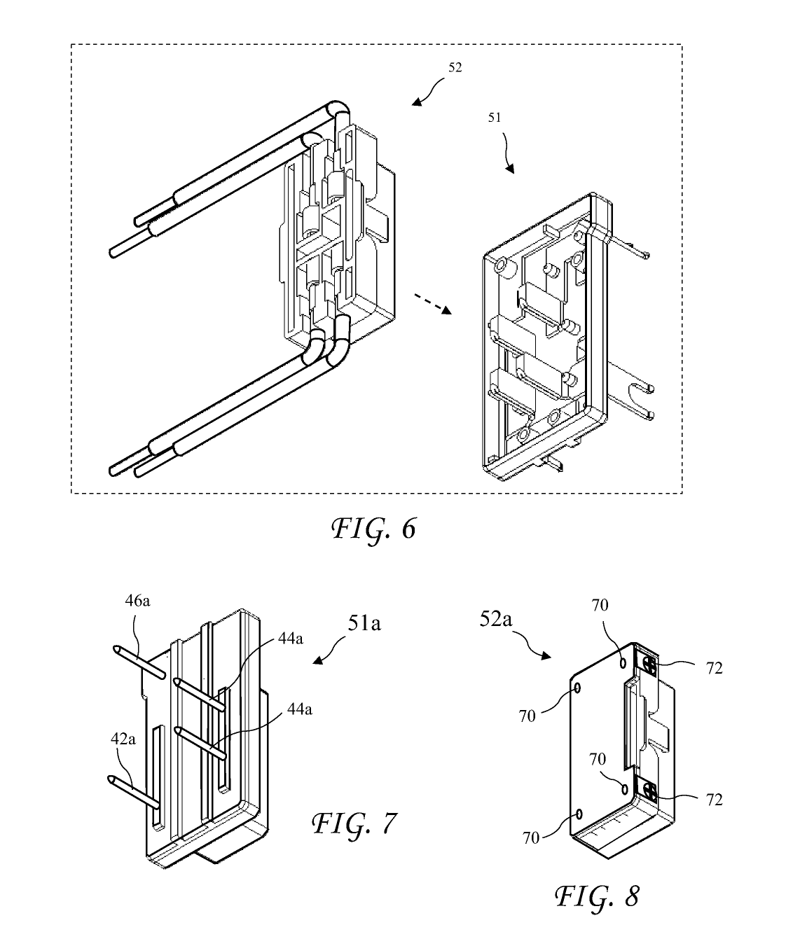

A rear perspective view of the two piece speed wire device 50 with covers removed to show internal elements is shown in FIG. 6.

An adapting device 51a with connectors comprising pins (or bayonet type connectors) 42a, 44a, and 46a (replacing forked lugs 42, 44, and 46) for electrically connecting to a known Ground Fault Circuit Interrupter (GFCI) receptacle is shown in FIG. 7. Some GFCI receptacle devices includes holes (or wire receptacles) normally used for insertion of solid core in-wall wiring into the body of the GFCI receptacles. The adapting device 51a allows simple and error proof connection of the GFCI receptacles. Similarly, the single piece speed wire device 40 may include pins replacing the forked lugs.

A pigtail device 52a according to the present invention including push-in wire receptacles 70 and/or screw type terminals 72 for connection to in-wall wiring is shown in FIG. 8. The lead wires 48 are eliminated on the pigtail device 52a while retaining the capability to pre-install the pigtail device and later plug the standard electrical device into the circuit using the adapting device 51. The push-in connections may be spring-type connections for retaining individual wires of the in-wall wiring, or include manual screw type retaining features in the pigtail device 52a for retaining the individual wires. Those skilled in the art will recognize various way to connect the in-wall wiring to a pigtail device 52, and a pigtail device 52 electrical connections electrically connectable in any manner to in-wall wiring is intended to come within the scope of the present invention.

The speed wiring devices according to the present invention are described above for a single traditional receptacle 10, but may be configured for any common receptacle device or switch or Ground Fault Circuit Interrupter (GFCI), device by merely adjusting the positioning of the forked lugs or pins. Further, pins may be used in lieu of forked lugs to connect to the GFCI device because GFCI devices typically have passages where individual wires are insertable, and then screws are tightened to secure the inserted wires. Any speed wiring device including forked lugs or pins positioned for connection to terminals of a traditional receptacle device, or switch device, or GFCI is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A speed wire device comprising:
a body;
at least two connector extending in a common direction away from the body and positioned on a face of the body and configured to electrically engage terminals on a standard electrical device;
at least two electrical connections, one of the electrical connections electrically connected to each of the connectors.

2. The speed wire device of claim 1, wherein the electrical connections are lead wires.

3. The speed wire device of claim 1, wherein the connectors are forked lugs positioned and configured to engage screw type connectors on the standard electrical device.

4. The speed wire device of claim 3, wherein the connectors are forked lugs positioned and configured to engage hot, neutral, and ground screw type connectors on the standard electrical device.

5. The speed wire device of claim 3, wherein the connectors are forked lugs positioned and configured to engage hot and neutral screw type connectors on the standard electrical device.

6. The speed wire device of claim 1, wherein the connectors are pins positioned and configured to engage wire receptacles on the standard electrical device.

7. The speed wire device of claim 6, wherein the connectors are pins positioned and configured to engage hot, neutral, and ground wire receptacles on the standard electrical device.

8. The speed wire device of claim 6, wherein the connectors are pins positioned and configured to engage hot and neutral wire receptacles on the standard electrical device.

9. The speed wire device of claim 6, wherein the connectors are pins positioned and configured to electrically connect to a Ground Fault Circuit Interrupter (GFCI) receptacle.

10. The speed wire device of claim 1, wherein the body comprises:
an adapting device including the connectors for electrically connecting to the standard electrical device; and
a pigtail device connected to in wall wiring, the pigtail device configured to electrically plug onto the adapting device to facilitate swapping the standard electrical device.

11. The speed wire device of claim 10, wherein pigtail device includes female connectors for electrically connecting to the adapting device, thereby reducing the likelihood of shocking an installer.

12. The speed wire device of claim 11, wherein pigtail device includes lead wires for permanently connecting to the in-wall wiring.

13. The speed wire device of claim 1, wherein the electrical connections are on the body.

14. The speed wire device of claim 13, wherein the electrical connections are screw type connectors on the body.

15. The speed wire device of claim 1, wherein the electrical connections are in the body.

16. The speed wire device of claim 1, wherein the electrical connections are in the body directly receiving individual wires of the in-wall wiring.

17. A speed wired electrical device comprising:
an electrical device selected from the group consisting of standard receptacle devices and standard switch devices, the electrical device including at least two terminals configured for electrically connecting directly to in-wall wiring;
a speed wire device comprising:
a body;
at least two connector extending in a common direction away from the body and positioned on a face of the body and configured to electrically engage terminals on a standard electrical device;
at least two lead wires, one of the lead wires electrically connected to each of the connectors.

18. A speed wired electrical device comprising:
an electrical device selected from the group consisting of standard receptacle devices and standard switch devices, the electrical device including at least three terminals including a hot terminal, a neutral terminal, and a ground terminal, the electrical device configured for electrically connecting directly to in-wall wiring;
a speed wire device comprising:
a body;
at least three connector extending in a common direction away from the body and positioned on a face of the body and configured to electrically engage terminals on a standard electrical device;
at least three lead wires, one of the lead wires electrically connected to each of the connectors.
